(19) United States
(12) Patent Application Publication
(10) Pub. No.: US 2022/0318472 A1
(43) Pub. Date: Oct. 6, 2022

(54) SIMULATION DEVICE, SIMULATION METHOD, SIMULATION SYSTEM, AND PROGRAM

(71) Applicant: ABLIC Inc., Tokyo (JP)

(72) Inventors: Fumiyasu UTSUNOMIYA, Tokyo (JP); Yusuke TAKEUCHI, Tokyo (JP); Yasuyuki MIYAHARA, Tokyo (JP); Ken ARAI, Tokyo (JP)

(21) Appl. No.: 17/705,690

(22) Filed: Mar. 28, 2022

(30) Foreign Application Priority Data
Apr. 6, 2021 (JP) 2021-064752

(51) Int. Cl. G06F 30/367

(52) U.S. Cl. CPC G06F 30/367; G06F 2119/06

(57) ABSTRACT

A simulation device includes: a model creation unit configured to create a simulation model of a test circuit, the test circuit including a boost circuit configured to receive power from a power generation element and output, to a load circuit, a boosted power obtained by boosting the received power, the power generation element being able to output a power smaller than power consumption of a load circuit, a capacitor provided between the power generation element and the boost circuit and configured to accumulate charge based on the received power from the power generation element and operate the boost circuit for a certain period of time by the accumulated charge, and at least one of the power generation element or the load circuit; and a simulation unit configured to simulate, based on the simulation model, at least one of (A) a charging operation of the capacitor or (B) a discharging operation from the capacitor in the test circuit.

### RELATED APPLICATIONS

This application claims priority to Japanese Patent Application No. 2021-064752, filed on Apr. 6, 2021, the entire content of which is incorporated herein by reference.

### BACKGROUND OF THE INVENTION

### 1. Field of the Invention

The present invention relates to a simulation device, a simulation method, a simulation system, and a program.

### 2. Description of the Related Art

A device for simulating an electrical circuit is known. Japanese Patent Application Laid-open No. 2019-122151 discloses a power simulation device configured to simulate a sensor system including a power generation element, a boost circuit, and a load circuit based on models of a power generation element, a boost circuit, and a load circuit.

### SUMMARY OF THE INVENTION

In light of this, the present invention is directed to performing appropriate simulation even in a case where power that can be output by a power generation element is smaller than power consumption of a load circuit.

A simulation device according to a first aspect of the present invention includes a model creation unit configured to create a simulation model of a test circuit, the test circuit including: (1) a boost circuit configured to receive power from a power generation element and output, to the load circuit, a boosted power obtained by boosting the received power, the power generation element being configured to output a power smaller than power consumption of a load circuit, (2) a capacitor provided between the power generation element and the boost circuit and configured to accumulate charge based on the received power from the power generation element and operate the boost circuit for a certain period of time by the accumulated charge, and (3) at least one of the power generation element or the load circuit; and a simulation unit configured to simulate, based on the simulation model, at least one of (A) a charging operation of the capacitor or (B) a discharging operation from the capacitor in the test circuit.

A simulation method according to a second aspect of the present invention is a simulation method executed by a computer, the method including creating a simulation model of a test circuit, the test circuit including: (1) a boost circuit configured to receive power from a power generation element and output, to a load circuit, a boosted power obtained by boosting the received power, the power generation element being configured to output a power smaller than power consumption of a load circuit, (2) a capacitor provided between the power generation element and the boost circuit and configured to accumulate charge based on the received power from the power generation element and operate the boost circuit for a certain period of time by the accumulated charge, and (3) at least one of the power generation element or the load circuit; and simulating, based on the simulation model, at least one of (A) a charging operation of the capacitor or (B) a discharging operation from the capacitor in the test circuit.

A simulation system according to a third aspect of the present invention includes an information terminal and a simulation device, in which the information terminal includes a data transmission unit configured to transmit, to the simulation device, power generation element characteristic data indicating electrical characteristics of a power generation element configured to output a power smaller than power consumption of a load circuit, and a display unit configured to display a result of simulation by the simulation device, and the simulation device includes a data acquisition unit configured to acquire the power generation element characteristic data, a model creation unit configured to create a simulation model of a test circuit, the test circuit including: (1) a boost circuit configured to receive power from the power generation element and output, to the load circuit, a boosted power obtained by boosting the received power, the power generation element being configured to output a power smaller than power consumption of a load circuit, (2) a capacitor provided between the power generation element and the boost circuit and configured to accumulate charge based on the received power from the power generation element and operate the boost circuit for a certain period of time by the accumulated charge, and (3) at least one of the power generation element or the load circuit, a simulation unit configured to simulate, based on the simulation model, at least one of (A) a charging operation of the capacitor or (B) a discharging operation from the capacitor in the test circuit, and a communication unit configured to transmit a result simulated by the simulation unit to the information terminal.

A program according to a fourth aspect of the present invention causes a computer to create a simulation model of a test circuit, the test circuit including: (1) a boost circuit configured to receive power from a power generation element and output, to a load circuit, a boosted power obtained by boosting the received power, the power generation element being configured to output a power smaller than power consumption of a load circuit, (2) a capacitor provided between the power generation element and the boost circuit and configured to accumulate charge based on the received power from the power generation element and operate the boost circuit for a certain period of time by the accumulated charge, and (3) at least one of the power generation element or the load circuit; and simulate, based on the simulation model, at least one of (A) a charging operation of the capacitor or (B) a discharging operation from the capacitor.

### BRIEF DESCRIPTION OF THE DRAWINGS

FIG. 1 is a schematic diagram of an electrical system serving as a target for simulation by a simulation device according to a present embodiment.

FIG. 2 is a schematic diagram of a simulation system including the simulation device.

FIG. 3 is a diagram illustrating a configuration of the simulation device.

FIG. 4 is a schematic diagram of a simulation model created by a model creation unit.

FIG. 5 is a diagram illustrating an example of a result of simulation by a simulation unit.

FIG. 6 is a flowchart illustrating an operation flow of the simulation device.

FIG. 7 is a schematic diagram of a simulation model according to a first modified example.

FIG. 8 is a schematic diagram of a simulation model according to a second modified example.

### DETAILED DESCRIPTION OF THE PREFERRED EMBODIMENTS

### Overview of Simulation Device 1

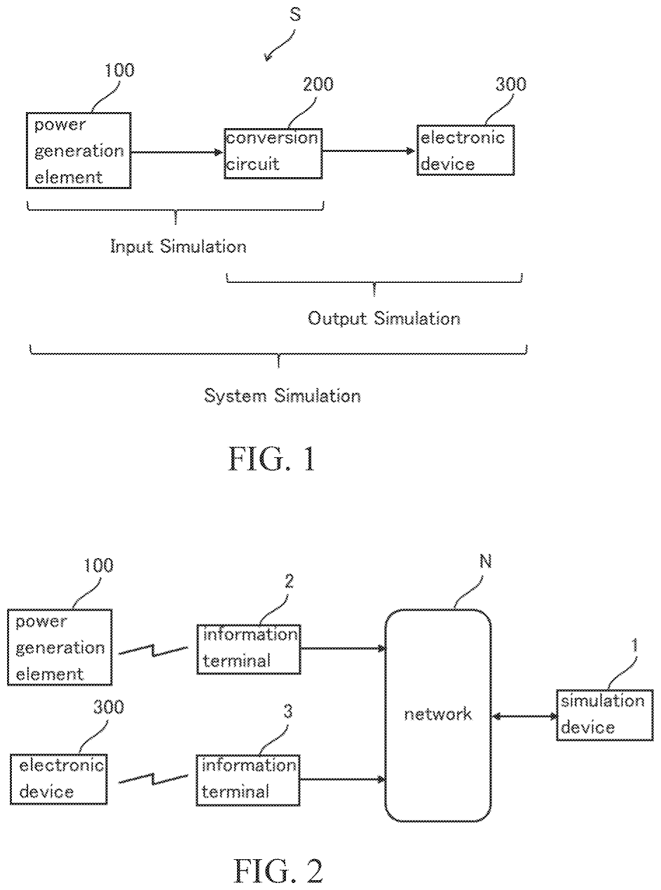

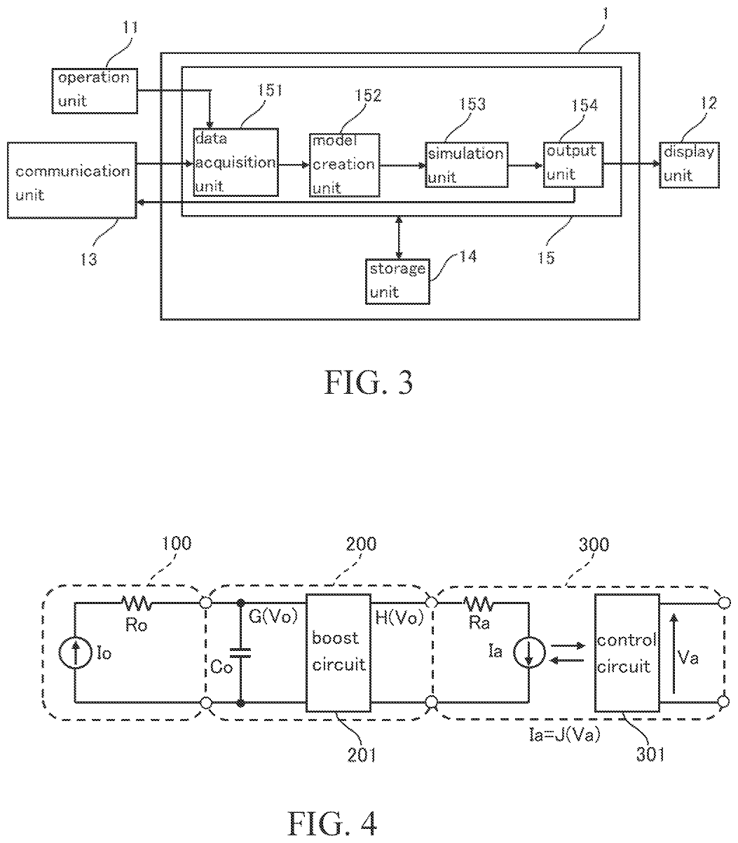

FIG. 1 is a schematic diagram of an electrical system S serving as a target for simulation by a simulation device 1 according to a present embodiment. FIG. 3 is a schematic diagram of a simulation system T including the simulation device 1.

The electrical system S includes a power generation element 100, a conversion circuit 200, and an electronic device 300. In the electrical system S, the voltage of power generated by the power generation element 100 is converted in the conversion circuit 200, and power of the converted voltage is supplied to the electronic device 300. The simulation device 1 simulates this operation of the electrical system S where power generated by the power generation element 100 is converted in the conversion circuit 200 and power of the converted voltage is supplied to the electronic device 300.

The simulation device 1 is, for example, a computer that executes a simulation program. The simulation device 1 executes at least one of input-side simulation corresponding to an operation of a test circuit including at least one of the power generation element 100 and the conversion circuit 200, output-side simulation corresponding to an operation of a test circuit including at least one of the conversion circuit 200 and the electronic device 300, or system simulation corresponding to an operation of a test circuit including at least one of the power generation element 100, the conversion circuit 200, and the electronic device 300.

The power generation element 100 is an element that generates a weak power. The power generation element 100 is an element that can output a power smaller than power consumption of a load circuit included in the electronic device 300. The power generation element 100 is, for example, an environmental power generation element such as an ultraviolet sensor, a solar sensor, a temperature sensor, a sugar sensor, a soil sensor, a sweat sensor, a water leakage sensor, an oil sensor, a gas sensor, a urine sensor, a plant sensor, a catalyst sensor, a vibration sensor, or an electromagnetic wave sensor.

The electronic device 300 includes a load circuit that operates based on power supplied from the conversion circuit 200. The electronic device 300 is a device that can operate intermittently. The electronic device 300 is, for example, a microcomputer, a communication controller, a light-emitting diode, a buzzer, or a motor, and outputs a signal or operates a mechanism based on a supplied power. The electronic device 300 may be an electronic device having a plurality of load circuits.

The power generated by the power generation element 100 is, for example, 1 mW or less. The power consumption of the load circuit included in the electronic device 300 is, for example, 10 mW or greater. In the electrical system S, the conversion circuit 200 accumulates the power generated by the power generation element 100 in a capacitor and then boosts the accumulated power. The capacitor accumulates the power generated by the power generation element 100 below an input voltage that can be boosted by the conversion circuit 200, which causes the voltage of the power input to the conversion circuit 200 to increase up to at least the input voltage that can be boosted by the conversion circuit 200.

Then, the conversion circuit 200 supplies the boosted power to the electronic device 300. The electronic device 300 transmits an electric wave intermittently or operates an actuator, based on the boosted power. With the electrical system S configured in this manner, although the power generated by the power generation element 100 is smaller than the power consumption of the load circuit included in the electronic device 300, the electronic device 300 can operate intermittently by the power generated by the power generation element 100.

However, in conventional simulation of an electric circuit including a power generation element, the operation of accumulating the power generated by the power generation element 100 in the capacitor and then boosting the accumulated power as described above has not been considered. Due to this, it has not been possible to appropriately perform simulation in a case where power that can be output by a power generation element is smaller than power consumption of a load circuit. The simulation device according to the present embodiment makes it possible to perform appropriate simulation in a case where power that can be output by a power generation element is smaller than power consumption of a load circuit, for the capacitor provided between the power generation element 100 and the conversion circuit 200.

In order for the simulation device 1 to simulate operation of the electrical system S, simulation models for the power generation element 100, the conversion circuit 200, and the electronic device 300 are required. The simulation device 1 acquires power generation element characteristic data indicating electrical characteristics of the power generation element 100 from an information terminal 2 connected via a network N, and acquires device characteristic data indicating electrical characteristics of the electronic device 300 from an information terminal 3 connected via the network N, for example, as illustrated in FIG. 2. The information terminal 2 and the information terminal 3 are each, for example, a smartphone, a tablet, or a personal computer.

The information terminal 2 includes, for example, a data transmission unit configured to transmit the power generation element characteristic data of the power generation element 100 to the simulation device 1, and a display unit configured to display a result of simulation by the simulation device 1. The information terminal 3 may include a data transmission unit configured to transmit the device characteristic data of the electronic device 300 to the simulation device 1, and a display unit configured to display a result of simulation by the simulation device 1.

The simulation device 1 uses at least some of the acquired power generation element characteristic data and the acquired device characteristic data to create a simulation model, and executes simulation. The simulation device 1 displays the result of simulation on a display, and causes a computer such as the information terminal 2 or the information terminal 3 to display the result.

The configuration and operation of the simulation device 1 will be described in detail below.

### Configuration of Simulation Device

FIG. 3 is a diagram illustrating a configuration of the simulation device 1. The simulation device 1 includes an operation unit 11, a display unit 12, a communication unit 13, a storage unit 14, and a control unit 15. The control unit 15 includes a data acquisition unit 151, a model creation unit 152, a simulation unit 153, and an output unit 154.

The operation unit 11 is a device that enables a user using the simulation device 1 to perform a simulation operation, and includes at least one of a keyboard and a mouse or a touch panel. The operation unit 11 notifies the data acquisition unit 151 of content of the operation performed by the user.

The display unit 12 is a device for displaying a screen on which the user performs various operations and a simulation result, and is a display, for example. The display unit 12 displays a simulation result output from the output unit 154.

The communication unit 13 includes a communication interface for transmitting/receiving data to/from an external device over a network such as the Internet or an intranet. The communication unit 13 receives the power generation element characteristic data indicating the electrical characteristics of the power generation element 100 from the information terminal 2 used by the user, a distributor, or a manufacturer of the power generation element 100, for example. The communication unit 13 may receive the power generation element characteristic data measured in an element measurement circuit connected to the network and the power generation element 100 from the element measurement circuit. The element measurement circuit is a circuit for measuring the electrical characteristics of the power generation element 100 in a state where the power generation element 100 serving as a simulation target is operated. The element measurement circuit may include a communication circuit that transmits the power generation element characteristic data. The information terminal 2 may function as the element measurement circuit.

In addition, the communication unit 13 may receive the device characteristic data indicating the electrical characteristics of the electronic device 300 from the information terminal 3 used by the user, a distributor, or a manufacturer of the electronic device 300. The communication unit 13 may receive the device characteristic data indicating the electrical characteristics of the electronic device 300 measured in a device measurement circuit connected to the network and the electronic device 300 from the device measurement circuit. The device measurement circuit is a circuit for measuring the electrical characteristics of the electronic device 300 in a state in which the electronic device 300 serving as a simulation target is operated. The device measurement circuit may include a communication circuit that transmits the device characteristic data. The information terminal 3 may function as the device measurement circuit. The communication unit 13 inputs the received device characteristic data to the data acquisition unit 151.

The communication unit 13 transmits the simulation result output by the output unit 154 to an external device. The communication unit 13 transmits the simulation result to, for example, a computer that transmits the power generation element characteristic data indicating the electrical characteristics of the power generation element 100, and a computer that transmits the device characteristic data indicating the electrical characteristics of the electronic device 300.

The storage unit 14 includes a storage medium such as a read only memory (ROM), a random access memory (RAM), or a hard disk. The storage unit 14 stores a program executed by the control unit 15. The storage unit 14 stores a simulation model used in a case where the control unit 15 executes simulation.

In addition, the storage unit 14 stores a model database in which a plurality of electrical characteristics of a plurality of the power generation elements 100 and a plurality of model candidates for the power generation element 100 are associated with each other. The model candidates for the power generation element 100 include an equivalent circuit of the power generation element 100 and constants of a plurality of elements included in the equivalent circuit. In the model database, at least one of model name and the electrical characteristics of the power generation element 100 and the model candidates are associated with each other. The electrical characteristics of the power generation element 100 are electrical characteristics of the power generation element 100 required to execute simulation and include, for example, an output resistance, an output current, or an output voltage of the power generation element 100.

In the model database, a plurality of electrical characteristics of a plurality of the electronic devices 300 and a plurality of electronic device model candidates may be further associated with each other. The electronic device model candidates include an equivalent circuit of the electronic device 300 and constants of a plurality of elements included in the equivalent circuit. The electrical characteristics of the electronic device 300 are electrical characteristics of the electronic device 300 required to execute simulation and include, for example, an input resistance, a consumption current, or a required input voltage of the electronic device 300.

The control unit 15 includes a central processing unit (CPU), for example. The control unit 15 executes the program stored in the storage unit 14 to function as the data acquisition unit 151, the model creation unit 152, the simulation unit 153, and the output unit 154.

The data acquisition unit 151 acquires the power generation element characteristic data indicating the electrical characteristics of the power generation element 100 via the communication unit 13. The data acquisition unit 151 notifies the model creation unit 152 of the acquired power generation element characteristic data. The data acquisition unit 151 may cause the storage unit 14 to store the power generation element characteristic data to notify the model creation unit 152 of the power generation element characteristic data.

As an example, the data acquisition unit 151 acquires the power generation element characteristic data measured in the element measurement circuit connected to the network and the power generation element 100 via the network. The data acquisition unit 151 acquires power generation element characteristic data indicating a relationship between an output voltage and an output current of the power generation element 100, for example. The data acquisition unit 151 acquires the power generation element characteristic data measured in the element measurement circuit, such that the simulation device 1 can perform simulation based on the electrical characteristics of the power generation element 100 in an actual usage environment, which improves the accuracy of the simulation. In particular, a model of the power generation element 100 including the power generation element characteristic data indicating the relationship between the output voltage and the output current of the power generation element 100 is created, such that a charging current value from the power generation element 100 can be accurately reproduced in terms of each charging voltage of the capacitor provided between the power generation element 100 and the conversion circuit 200. Thus, the accuracy of simulation in which charging of the capacitor provided between the power generation element 100 and the conversion circuit 200 is performed using the power generated by the power generation element can be greatly improved.

The data acquisition unit 151 may acquire the device characteristic data indicating the electrical characteristics of the electronic device 300 measured in the device measurement circuit connected to the network and the electronic device 300, via the network. The data acquisition unit 151 acquires, as the device characteristic data, an operation time of the electronic device for a predetermined period of time, and a current profile indicating the relationship between time and an input current. The data acquisition unit 151 acquires the device characteristic data obtained using the device measurement circuit, such that the simulation device 1 can perform simulation based on the electrical characteristics of the electronic device 300 in an actual usage environment, which improves the accuracy of the simulation.

Here, for modeling the electronic device 300, an average consumption current during operation of the electronic device 300 may be calculated, and a resistive element model having a resistance value corresponding to the average consumption current may be used. That is, the model creation unit 152 replaces the electronic device 300 with the resistive element having the resistance value corresponding to the average consumption current of the electronic device 300 to create a simulation model for the electronic device 300 portion. In this way, the simulation based on the electrical characteristics of the electronic device 300 is not complicated, and shorter simulation time and improved accuracy of the simulation can be expected. Note that, in the electronic device 300 that performs an intermittent operation by normal operation (OPE)/standby (STANDBY), the average consumption current (I_{AVE}) can be calculated by the following equation, assuming that I_{OPE} is a normal operation consumption current, I_{STANDBY} is a standby operation consumption current, T_{OPE} is a normal operation time, and T_{STANDBY} is a standby operation time.

$${I}_{AVE} = \frac{{I}_{OPE} \times {T}_{OPE} + {I}_{STANDBY} \times {T}_{STANDBY}}{{T}_{OPE} + {T}_{STANDBY}}$$

The model creation unit 152 creates a simulation model for simulating operation of a test circuit in which the power generation element 100 and the conversion circuit 200 are connected. The model creation unit 152 creates a simulation model of a test circuit including the power generation element 100, a boost circuit configured to boost power output by the power generation element 100 and output the boosted power to a load circuit, and a capacitor provided between the power generation element 100 and the boost circuit. The model creation unit 152 may create a simulation model for simulating an operation in a state where the electronic device 300 is further connected.

In other words, the model creation unit 152 creates a simulation model of a test circuit including (1) a boost circuit configured to receive power from a power generation element and output, to a load circuit, a boosted power obtained by boosting the received power, the power generation element being configured to output a power smaller than power consumption of a load circuit, (2) a capacitor provided between the power generation element 100 and the boost circuit and configured to accumulate charge based on the received power from the power generation element and operate the boost circuit using the accumulated charge for a certain period of time, and (3) at least one of the power generation element 100 or the load circuit. The model creation unit 152 may create a simulation model of a case where the boost circuit is intermittently operated a plurality of times, or may create a simulation model of a case where the boost circuit is operated only once. The model creation unit 152 may create the simulation model by configuring a simulation model stored in advance in the storage unit 14 with a numerical value acquired by the data acquisition unit 151 via the operation unit 11 or the communication unit 13.

The model creation unit 152 inputs the created simulation model to the simulation unit 153. The model creation unit 152 may store the created simulation model in the storage unit 14.

FIG. 4 is a schematic diagram of a simulation model created by the model creation unit 152. The model creation unit 152 creates a model including a current source Io and an output resistor Ro as a simulation model for the power generation element 100. The model creation unit 152 creates the simulation model of the power generation element 100 based on the power generation element characteristic data of the power generation element 100 acquired by the data acquisition unit 151, for example. Specifically, the model creation unit 152 refers to the model database stored in the storage unit 14 and selects, from a plurality of model candidates for the power generation element 100, a model candidate for the power generation element 100 that corresponds to the electrical characteristics indicated by the power generation element characteristic data acquired by the data acquisition unit 151 to create the simulation model of the power generation element 100.

Furthermore, as illustrated in FIG. 4, for example, the model creation unit 152 creates a simulation model of the conversion circuit 200 including a capacitor Co and a boost circuit 201. The model creation unit 152 creates a simulation model of the conversion circuit 200 by, for example, determining a constant of the capacitor Co for allowing the boost circuit 201 to boost a power of a voltage G (Vo) input from the power generation element 100 to a predetermined voltage H (Vo), based on the electrical characteristics of the power generation element 100. The model creation unit 152 may use a model candidate selected from a plurality of model candidates for the boost circuit 201 to create a simulation model of the conversion circuit 200.

The model creation unit 152 may create a simulation model of a test circuit in which power generated by the power generation element 100 is smaller than a driving power of the boost circuit 201, and power that can be accumulated in the capacitor Co is larger than power generated by the power generation element 100 for a certain period of time, in consideration of the driving power required to operate the boost circuit 201 for the certain period of time. Furthermore, the model creation unit 152 may create a simulation model of a test circuit in which power that can be accumulated in the capacitor Co is larger than a driving power required to operate the load circuit for a certain period of time.

The model creation unit 152 may create a simulation model of the conversion circuit 200 further based on the electrical characteristics of the electronic device 300. The model creation unit 152 creates a simulation model of the conversion circuit 200 that can output a voltage satisfying the consumption current and the required input voltage of the electronic device 300, for example. Specifically, the model creation unit 152 may determine a constant of the capacitor Co for allowing the boost circuit 201 to output the consumption current of the electronic device 300 to create the simulation model of the conversion circuit 200.

The model creation unit 152 may create a simulation model including the boost circuit 201 that starts operation in response to a voltage equal to or greater than a predetermined first threshold being input from the capacitor Co, and then stops the operation in response to the output voltage of the capacitor Co dropping to a second threshold voltage lower than the first threshold voltage. In a state where the operation is not started, in response to the output voltage of the capacitor Co becoming the first threshold or greater, the boost circuit 201 generates a power output to the electronic device 300, and performs a boosting operation with the generated power. With the boost circuit 201 configured in this manner, even in a case where the voltage of the capacitor Co becomes less than the first threshold, the boost circuit 201 can continue the operation until the voltage becomes less than the second threshold.

A capacitance of the capacitor Co may be any capacitance, but as an example, in a case where the electronic device 300 has a Bluetooth low energy (BLE, trade name) circuit and the circuit needs to be operated for 0.5 seconds, the capacitance of the capacitor Co is, for example, 5 mF. This capacitance is much larger than a μF order capacitance in a case where the capacitor is used as a bypass capacitor intended to remove noise.

Furthermore, the model creation unit 152 may create a simulation model of the electronic device 300. The model creation unit 152 creates a simulation model of the electronic device 300 including an input resistor Ra and the control circuit 301, as illustrated in FIG. 4, for example. The control circuit 301 generates, for example, a pulse signal indicating a timing of operating the electronic device 300 and outputs a signal of a voltage Va for a period of generating the pulse signal. The electronic device 300 consumes a current Ia that is determined based on the voltage Va for a period during which the control circuit 301 outputs the voltage Va.

The simulation unit 153 simulates the operation of the boost circuit 201 and the capacitor Co by the power generated by the power generation element 100 based on the simulation model created by the model creation unit 152. The simulation unit 153 creates image data of a waveform indicating at least one of an output voltage or an output current of the conversion circuit 200, for example. The simulation unit 153 may create image data indicating the relationship between at least one of an input voltage or an input current of the boost circuit 201 and at least one of the output voltage or the output current of the boost circuit 201. The simulation unit 153 inputs the created image data to the output unit 154. The output unit 154 causes the display unit 12 to display the input image data or transmits the input image data to an external device via the communication unit 13.

The simulation unit 153 simulates an operation of supplying some of the power charged in the capacitor Co to the electronic device 300 while the capacitor Co is charged using the power generated by the power generation element 100, based on a simulation model in which a model of the power generation element 100, a model of the capacitor Co, and the electronic device model corresponding to the electrical characteristics of the electronic device 300 are connected to each other.

The simulation unit 153 simulates an operation of charging the capacitor Co having a capacitance determined based on the electrical characteristics indicated by the power generation element characteristic data acquired by the data acquisition unit 151, for example. The simulation unit 153 may perform simulation based on a simulation model including the capacitor Co, the capacitor Co having a capacitance determined based on the electrical characteristics of the electronic device 300 connected for use to the conversion circuit 200, which is an electronic circuit corresponding to the simulation model. The simulation unit 153 simulates the operation of charging the capacitor Co having the capacitance determined in this way, so that a user using the power generation element 100 and the electronic device 300 can determine whether the determined capacitance of the capacitor Co is appropriate.

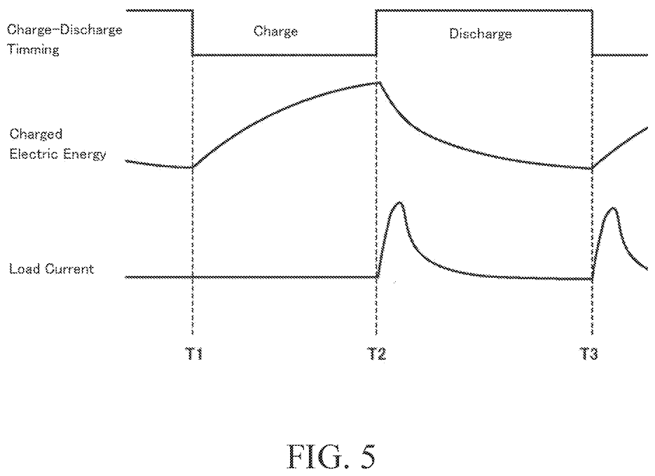

FIG. 5 is a diagram illustrating an example of a result of simulation by the simulation unit 153. FIG. 5 illustrates a first waveform indicating an operation state of the conversion circuit 200, a second waveform indicating an amount of power accumulated in the capacitor Co, and a third waveform indicating an operating current of the load circuit of the electronic device 300.

A period of time during which the first waveform is at a low level (the period from time T1 to time T2) is a charging period during which power output by the power generation element 100 is accumulated, and the amount of accumulated power indicated by the second waveform increases over time. A period of time during which the first waveform is at a high level (the period from time T2 to time T3) is a discharging period during which the power accumulated in the capacitor Co included in the conversion circuit 200 is discharged.

In the storage period, the power generated by the power generation element 100 is accumulated in the capacitor Co, and the boost circuit 201 does not consume the accumulated power. In the discharging period, the boost circuit 201 consumes the power accumulated in the capacitor Co. In the discharging period, the load circuit is operated as indicated by the third waveform and a load current flows, so that the amount of accumulated power indicated by the second waveform decreases over time. The user can determine whether the electronic device 300 can be operated using the power generation element 100 and the conversion circuit 200 for which simulation has been performed, by confirming the waveforms illustrated in FIG. 5. The output unit 154 may output information indicating whether the electronic device 300 can be operated using the power generation element 100 and the conversion circuit 200 for which simulation has been performed.

The simulation unit 153 may simulate an operation of outputting the power to the electronic device 300 after the output voltage of the capacitor Co becomes equal to or greater than the first threshold and the boost circuit 201 starts the operation of boosting the output power of the capacitor Co. In this case, in a case where the output power of the capacitor Co is less than the first threshold, the simulation unit 153 may stop the simulation and notify the output unit 154 that an error has occurred. For example, if, as a result of simulation, a voltage between both ends of the capacitor Co at a time point when the power output by the power generation element 100 has been accumulated in the capacitor Co for a non-operation period in a case where the electronic device 300 intermittently operates is less than the first threshold, the simulation unit 153 stops the simulation.

As described above, the first threshold is a minimum input voltage required for the boost circuit 201 to perform boosting, for example. The first threshold may be a minimum input voltage required for the boost circuit 201 to perform boosting to a voltage required to operate the electronic device 300. The output unit 154 outputs error information indicating that boosting to the voltage required to operate the electronic device 300 cannot be performed. By the simulation unit 153 and the output unit 154 operating in this way, the user can recognize that it is impossible to generate the voltage required to operate the electronic device 300 by using the conversion circuit 200.

In a case where, as a result of the simulation, the output voltage of the capacitor Co is less than the first threshold, the simulation unit 153 may instruct the model creation unit 152 to change the capacitance of the capacitor Co in the simulation model. The simulation unit 153 causes the model creation unit 152 to create a simulation model in which the capacitance of the capacitor Co is increased, for example, and performs simulation again using the created simulation model.

In a case where, as a result of the simulation, the output voltage of the capacitor Co is less than the first threshold, the simulation unit 153 may instruct the model creation unit 152 to change the period of time during which the power output by the power generation element 100 is accumulated, in the simulation model. In other words, the simulation unit 153 causes the model creation unit 152 to create a simulation model in which the capacitance of the capacitor Co is increased and the period of time during which the power output by the power generation element 100 is accumulated is increased, for example, and performs the simulation again using the created simulation model.

The simulation unit 153 may perform simulation a plurality of times using a simulation model changed in this manner until the output voltage of the capacitor Co becomes equal to or greater than the first threshold. By the simulation unit 153 repeating such simulation, the user can determine parameters of the conversion circuit 200 suitable for operating the electronic device 300 by using the power generation element 100.

In a case where, as a result of the simulation, a current that can be output by the conversion circuit 200 is smaller than a current required to operate the electronic device 300, the simulation unit 153 may stop the simulation and notify the output unit 154 that an error has occurred. The output unit 154 outputs error information indicating that the conversion circuit 200 cannot output the current required to operate the electronic device 300. By the simulation unit 153 and the output unit 154 operating in this manner, the user can recognize that the conversion circuit 200 cannot output the current required to operate the electronic device 300.

After the boost circuit 201 starts the operation of boosting the output power of the capacitor Co, at the time when the power accumulated in the capacitor Co decreases and the output voltage of the capacitor Co becomes less than the second threshold, the simulation unit 153 may simulate an operation of stopping the boosting operation of the boost circuit 201. In a case where the result of simulation indicates that the boost circuit 201 stops the boosting operation before a period of time required to operate the electronic device 300 elapses, the simulation unit 153 may output error information indicating that the capacitance of the capacitor Co is insufficient.

In a case where the result of simulation indicates that the boost circuit 201 stops the boosting operation before the period of time required to operate the electronic device 300 elapses, the simulation unit 153 may cause the model creation unit 152 to create a simulation model in which the capacitance of the capacitor Co is increased and perform the simulation again using the created simulation model. In this case, the simulation unit 153 may repeat the simulation until the output voltage of the capacitor Co is maintained at or above the second threshold while the period of time required to operate the electronic device 300 elapses. By the simulation unit 153 repeating such simulation, the user can determine the capacitance of the capacitor Co such that the conversion circuit 200 can output power over a period of time required to operate the electronic device 300 by using the power generation element 100.

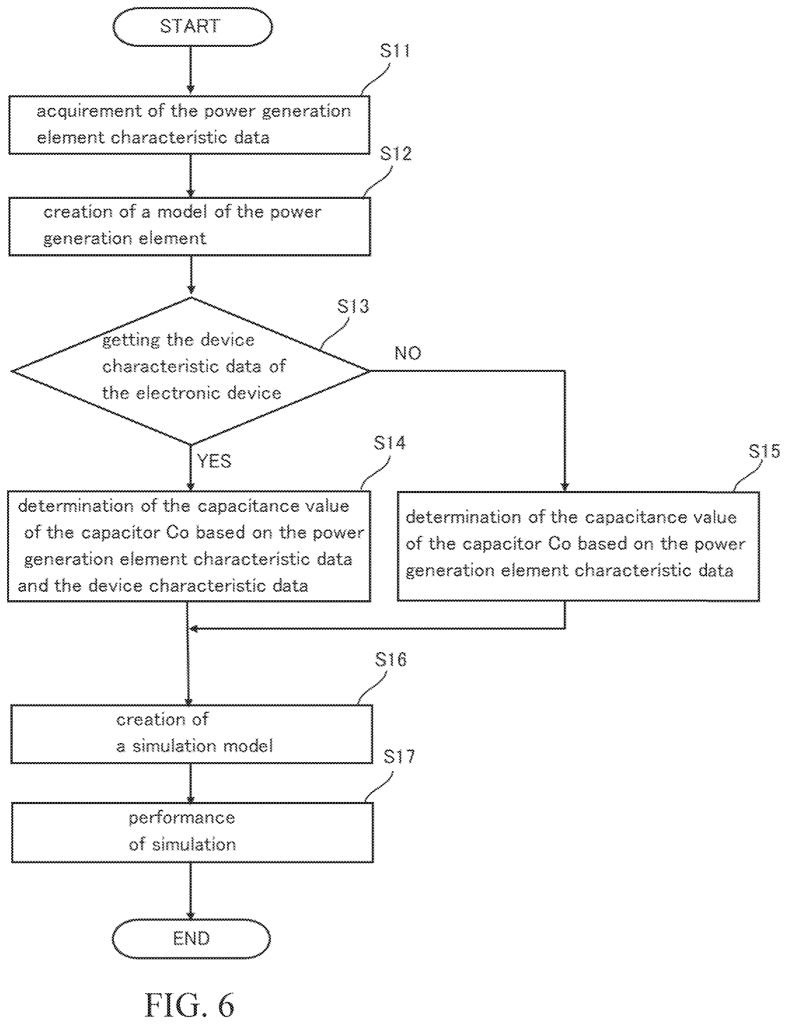

FIG. 6 is a flowchart illustrating an operation flow of the simulation device 1. The flowchart illustrated in FIG. 6 starts from a time point at which the data acquisition unit 151 acquires an instruction to perform simulation via the operation unit 11 or the communication unit 13.

The data acquisition unit 151 acquires the power generation element characteristic data of the power generation element 100. The data acquisition unit 151 acquires the power generation element characteristic data indicating, for example, a result of actually measuring the electrical characteristics of the power generation element 100 via the communication unit 13 (S11). The model creation unit 152 creates a model of the power generation element 100 based on the power generation element characteristic data acquired by the data acquisition unit 151 (S12).

In a case where the device characteristic data of the electronic device 300 is acquired via the data acquisition unit 151 (YES in S13), the model creation unit 152 determines the capacitance value of the capacitor Co based on the power generation element characteristic data and the device characteristic data (S14). The model creation unit 152 determines the capacitance value of the capacitor Co to a capacitance value suitable for the boost circuit 201 to boost the voltage of the power output by the power generation element 100 to a voltage required by the electronic device 300, for example. In a case where the device characteristic data of the electronic device 300 is not acquired (NO in S13), the model creation unit 152 determines the capacitance value of the capacitor Co based on the power generation element characteristic data (S15).

The model creation unit 152 creates a simulation model based on the determined capacitance value (S16). The model creation unit 152 creates a simulation model by determining a length of a period of time of charging to the capacitor Co and a length of a period of time of discharging from the capacitor Co based on the device characteristic data of the electronic device 300, for example. The simulation unit 153 performs simulation using the simulation model created by the model creation unit 152 (S17).

### Input-side Simulation and Output-side Simulation

In the above description, a case where the simulation device 1 performs simulation of the entire system including the power generation element 100, the conversion circuit 200, and the electronic device 300 has been exemplified, but the simulation device 1 may perform simulation of the operation of the power generation element 100 and the conversion circuit 200 (input-side simulation), and simulation of the operation of the conversion circuit 200 and the electronic device 300 (output-side simulation).

In a case where the data acquisition unit 151 receives an instruction to perform the input-side simulation, the model creation unit 152 creates a simulation model of the power generation element 100 and the conversion circuit 200 based on the power generation element characteristic data indicating the electrical characteristics of the power generation element 100. The simulation unit 153 performs simulation of outputting, for example, an output voltage of the power generation element 100, a voltage waveform between both ends of the capacitor Co in a case where the power generation element 100 generates power, and a voltage waveform output by the conversion circuit 200. By the simulation device 1 performing such input-side simulation, the user can confirm what voltage the conversion circuit 200 outputs based on the power generated by the power generation element 100.

In a case where the data acquisition unit 151 receives an instruction to perform the output-side simulation, the model creation unit 152 creates a simulation model of the conversion circuit 200 and the electronic device 300 based on the device characteristic data of the electronic device 300. The simulation unit 153 performs simulation of an operation of operating the electronic device 300 based on power output by the conversion circuit 200. The simulation unit 153 performs simulation of outputting, for example, a voltage waveform between both ends of the capacitor Co, an output voltage waveform of the boost circuit 201, and a waveform of the current flowing through the electronic device 300. By the simulation device 1 performing such output-side simulation, the user can confirm whether the electronic device 300 operates based on the power supplied from the conversion circuit 200.

### First Modified Example

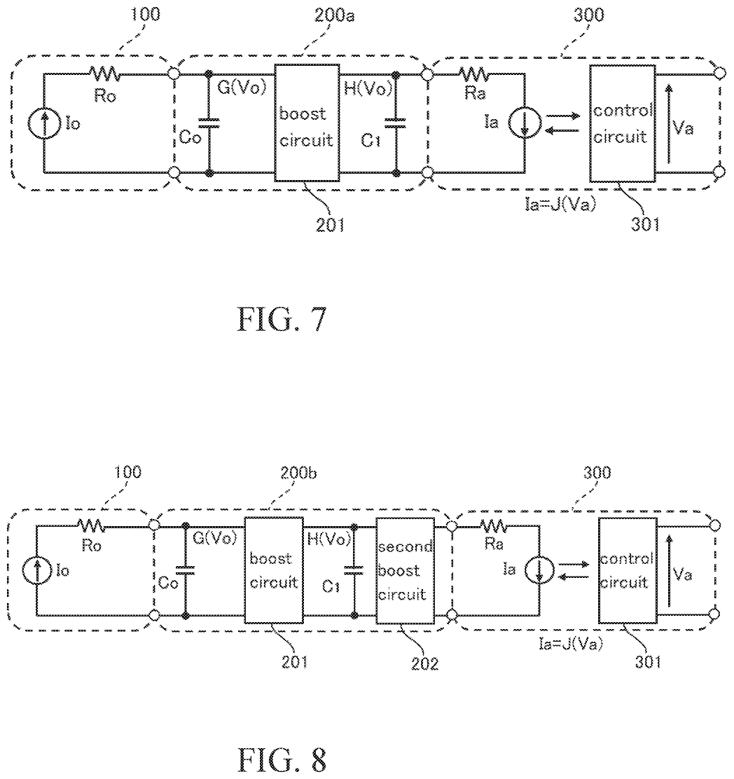

FIG. 7 is a schematic diagram of a simulation model according to a first modified example. In a test circuit corresponding to the simulation model illustrated in FIG. 7, a conversion circuit 200a is provided in place of the conversion circuit 200 illustrated in FIG. 4. The schematic diagram of FIG. 7 differs from the schematic diagram of the simulation model illustrated in FIG. 4 in that, in the conversion circuit 200a, a second capacitor C1 is provided between the boost circuit 201 and the electronic device 300 that functions as a load circuit, and is the same as the schematic diagram in FIG. 4 in other respects. In the simulation model, the power that can be accumulated in the capacitor Co is smaller than a driving power required to operate the electronic device 300 for a certain period of time, and the second capacitor C1 can accumulate the power required to operate the electronic device 300 for the certain period of time. According to this configuration, simulation can be appropriately performed even in a case where the driving power (power consumption) of the electronic device 300 is relatively large.

### Second Modified Example

FIG. 8 is a schematic diagram of a simulation model according to a second modified example. In a test circuit corresponding to the simulation model illustrated in FIG. 8, a conversion circuit 200b is provided in place of the conversion circuit 200a illustrated in FIG. 7. In the conversion circuit 200b, a second boost circuit 202 is connected between the second capacitor C1 and the electronic device 300. In a case where the second capacitor C1 is provided in the test circuit, a voltage for driving the second boost circuit 202 is higher than a voltage for driving the boost circuit 201, and thus the capacitance of the second capacitor C1 may be smaller than the capacitance of the first capacitor Co. In a case where the capacitance of the first capacitor Co is 5 mF, the capacitance of the second capacitor C1 is, for example, 680 μF. According to this configuration, simulation can be appropriately performed even in a case where the driving power (power consumption) of the electronic device 300 is relatively large.

### Effects by Simulation Device 1

As described above, the model creation unit 152 creates a simulation model of a circuit including the power generation element 100 that can output a power smaller than the power consumption of the load circuit, the boost circuit 201 that boosts the power output by the power generation element 100 and outputs the boosted power to the electronic device 300, and the capacitor Co provided between the power generation element 100 and the boost circuit 201. The simulation unit 153 simulates the operation of the boost circuit 201 by the power generated by the power generation element 100 based on the simulation model created by the model creation unit 152. Because the simulation device 1 is configured in this manner, the simulation device 1 can simulate operation in a case where the conversion circuit 200 boosts the power output by the power generation element 100 even in a case where the power that can be output by the power generation element 100 is smaller than the power consumption of the electronic device 300.

The present invention has been described above in the form of embodiments, but the technical scope of the present invention is not limited to the scope described in the above-described embodiments, and various modifications and changes can be made within the scope of the present invention. For example, all or a part of the device may be functionally or physically dispersed in any units and integrated. Furthermore, a new embodiment generated by any combination of a plurality of the embodiments is also included in the embodiments of the present invention. The effects of the new embodiment generated by the combination have the effects of the original embodiments.

What is claimed is:

1. A simulation device comprising:
a model creation unit configured to create a simulation model of a test circuit, the test circuit including:
(1) a boost circuit configured to receive power from a power generation element and output, to a load circuit, a boosted power obtained by boosting the received power, the power generation element being configured to output a power smaller than power consumption of the load circuit,
(2) a capacitor provided between the power generation element and the boost circuit and configured to accumulate charge based on the received power from the power generation element and operate the boost circuit for a certain period of time by the accumulated charge, and
3) at least one of the power generation element or the load circuit; and
a simulation unit configured to simulate, based on the simulation model, at least one of (A) a charging operation of the capacitor or (B) a discharging operation from the capacitor in the test circuit.

2. The simulation device according to claim 1, wherein the model creation unit creates the simulation model of the test circuit in which the power generated by the power generation element is smaller than a driving power of the boost circuit, and power to be accumulated in the capacitor is greater than the power generated by the power generation element for the certain period of time, in consideration of a driving power required to operate the boost circuit for the certain period of time.

3. The simulation device according to claim 1, wherein the model creation unit creates the simulation model of the test circuit in which the power to be accumulated in the capacitor is greater than the driving power required to operate the load circuit for the certain period of time.

4. The simulation device according to claim 2, wherein the model creation unit creates the simulation model of the test circuit including a second capacitor between the boost circuit and the load circuit, and
in the test circuit, the power to be accumulated in the capacitor is smaller than a driving power required to operate the load circuit for the certain period of time and the second capacitor is configured to accumulate the power required to operate the load circuit for the certain period of time.

5. The simulation device according to claim 4, wherein the model creation unit creates the simulation model of the test circuit in which a second boost circuit is connected between the second capacitor and the load circuit.

6. The simulation device according to claim 1, further comprising:
a data acquisition unit configured to acquire power generation element characteristic data indicating electrical characteristics of the power generation element, wherein the model creation unit creates a model of the power generation element based on the power generation element characteristic data.

7. The simulation device according to claim 6, wherein the data acquisition unit acquires the power generation element characteristic data indicating a relationship between an output voltage and an output current of the power generation element.

8. The simulation device according to claim 6, wherein the data acquisition unit acquires the power generation element characteristic data measured in an element measurement circuit connected to a network and the power generation element, via the network.

9. The simulation device according to claim 6, wherein the model creation unit refers to a database in which a plurality of electrical characteristics of a plurality of the power generation elements and a plurality of power generation element model candidates are associated with each other, and selects a power generation element model candidate that corresponds to electrical characteristics indicated by the power generation element characteristic data acquired by the data acquisition unit from the plurality of power generation element model candidates to create a model of the power generation element.

10. The simulation device according to claim 1, wherein the simulation unit simulates an operation in which, in a case where an output power of the capacitor is equal to or greater than a threshold, the boost circuit outputs a power obtained by boosting the output power to an electronic device.

11. The simulation device according to claim 1, wherein the simulation unit performs simulation based on the simulation model of the test circuit including the capacitor, the capacitor having a capacitance determined based on electrical characteristics of the load circuit connected for use to an electronic circuit corresponding to the simulation model.

12. The simulation device according to claim 11, further comprising:
a data acquisition unit configured to acquire characteristic data indicating electrical characteristics of the electronic device measured in a device measurement circuit connected to a network and the electronic device, via the network,
wherein the simulation unit simulates an operation of charging the capacitor, the capacitor having a capacitance determined based on the electrical characteristics indicated by the characteristic data.

13. The simulation device according to claim 12, wherein the data acquisition unit acquires, as the characteristic data, an operation time of the electronic device for a predetermined time, and a current profile indicating a relationship between time and an input current.

14. The simulation device according to claim 13, wherein the data acquisition unit calculates an average consumption current during operation of the electronic device based on the operation time of the electronic device and the current profile, and
the model creation unit replaces the electronic device with a resistive element having a resistance value corresponding to the average consumption current of the electronic device to create a simulation model of the load circuit.

15. The simulation device according to claim 12, wherein the simulation unit simulates an operation in which some of a power charged to the capacitor is supplied to the electronic device while the capacitor is being charged using the power generated by the power generation element, based on the simulation model in which a model of the power generation element, a model of the capacitor, and an electronic device model corresponding to the electrical characteristics of the electronic device are connected to each other.

16. A simulation method executed by a computer, the method comprising:
creating a simulation model of a test circuit, the test circuit including:
(1) a boost circuit configured to receive power from a power generation element and output, to a load circuit, a boosted power obtained by boosting the received power, the power generation element being configured to output a power smaller than power consumption of the load circuit,
(2) a capacitor provided between the power generation element and the boost circuit and configured to accumulate charge based on the received power from the power generation element and operate the boost circuit for a certain period of time by the accumulated charge, and
(3) at least one of the power generation element or the load circuit; and
simulating, based on the simulation model, at least one of (A) a charging operation of the capacitor or (B) a discharging operation from the capacitor in the test circuit.

17. A simulation system comprising an information terminal and a simulation device, wherein the information terminal includes:
a data transmission unit configured to transmit, to the simulation device, power generation element characteristic data indicating electrical characteristics of a power generation element configured to output a power smaller than power consumption of a load circuit, and
a display unit configured to display a result of simulation by the simulation device, and
the simulation device includes:
a data acquisition unit configured to acquire the power generation element characteristic data,
a model creation unit configured to create a simulation model of a test circuit, the test circuit including (1) a boost circuit configured to receive power from the power generation element and output, to the load circuit, a boosted power obtained by boosting the received power, the power generation element being configured to output a power smaller than power consumption of the load circuit, (2) a capacitor provided between the power generation element and the boost circuit and configured to accumulate charge based on the received power from the power generation element and operate the boost circuit for a certain period of time by the accumulated charge, and (3) at least one of the power generation element or the load circuit, and
a simulation unit configured to simulate, based on the simulation model, at least one of (A) a charging operation of the capacitor or (B) a discharging operation from the capacitor in the test circuit, and
a communication unit configured to transmit a result of simulation by the simulation unit to the information terminal.

18. A non-transitory storage medium storing an information processing program executed by a computer to:
create a simulation model of a test circuit, the test circuit including:
(1) a boost circuit configured to receive power from a power generation element output, to a load circuit, a boosted power obtained by boosting the input power, the power generation element being configured to output a power smaller than power consumption of the load circuit,
(2) a capacitor provided between the power generation element and the boost circuit and configured to accumulate charge based on the received power from the power generation element and operate the boost circuit for a constant period of time by the accumulated charge, and (3) at least one of the power generation element or the load circuit; and
simulate, based on the simulation model, at least one of (A) a charging operation of the capacitor or (B) a discharging operation from the capacitor.
